(19) United States
(12) Patent Application Publication
(10) Pub. No.: US 2018/0372146 A1
(43) Pub. Date: Dec. 27, 2018

(54) FINE GRAIN STEEL ALLOY AND AUTOMOTIVE COMPONENTS FORMED THEREOF

(71) Applicant: GM GLOBAL TECHNOLOGY OPERATIONS LLC, DETROIT, MI (US)

(72) Inventors: Huaxin Li, Rochester Hills, MI (US); Daniel J Wilson, Pomtiac, MI (US)

(21) Appl. No.: 15/632,722

(22) Filed: Jun. 26, 2017

(51) Int. Cl. F16C 3/06; C22C 38/02; C22C 38/38; C22C 38/12; C22C 38/06; C22C 38/00

(52) U.S. Cl. CPC F16C 3/06; C22C 38/02; C22C 38/001; C22C 38/12; C22C 38/06; C22C 38/38

(57) ABSTRACT

A fine grain steel alloy and automotive components produced therefrom are provided. The fine grain steel alloy includes iron, about 0.20 to about 0.60 weight percent carbon, about 1.80 to about 2.50 weight percent manganese, about 0.20 to about 1.20 weight percent silicon, and about 0.10 to about 0.25 weight percent of a transition metal, where the transition metal is vanadium, niobium, or a combination of vanadium and niobium. The fine grain steel alloy may also include about 0.60 to about 1.50 weight percent chromium, about 0.01 to about 0.20 weight percent aluminum, and about 0.01 to about 0.20 weight percent titanium.

### FIELD

The present disclosure relates generally to steel alloys, and more particularly, to fine grain steel alloys that have improved fatigue life and mechanical properties, as well as components made therefrom, such crankshafts and transmission shafts.

### INTRODUCTION

Typical steel alloys are forged and then subjected to a quench and temper (QT) process. Hardenability in some typical steel alloys may be about 1.2 DI (ideal diameter hardenability) after the forging step. The conventional quench and temper (QT) process is used to refine grain size and increase base metal strength. The QT process involves rapid cooling from a heated state to put the metal into a hard state. This involves extra steps beyond what is required for forging.

### SUMMARY

This disclosure provides hard steel alloys that can be created with a high hardness without the need for the QT process after the forging step. For example, the steel alloys of the present disclosure may have a hardenability of at least 7.9 DI without quenching and tempering. In some examples, a final strength of 1400 MPa (HRC 43) may be achieved.

The disclosed steel alloy may contain iron, manganese, silicon, and at least one of vanadium and niobium. The microstructure may include fine grains including bainite and a small amount of martensite and pearlite.

In one example, which may be combined with or separate from the other examples and features provided herein, a fine grain steel alloy is provided containing: iron, about 0.20 to about 0.60 weight percent carbon, about 1.80 to about 2.50 weight percent manganese, about 0.20 to about 1.20 weight percent silicon, and about 0.10 to about 0.25 weight percent of a transition metal, where the transition metal consists of at least one of vanadium and niobium.

In another example, which may be combined or separate from the other examples and features provided herein, an automotive propulsion system component is provided that is formed of a fine grain steel alloy. The fine grain steel alloy comprises iron, about 0.20 to about 0.60 weight percent carbon, about 1.80 to about 2.50 weight percent manganese, about 0.20 to about 1.20 weight percent silicon, and about 0.10 to about 0.25 weight percent of a transition metal, where the transition metal consists of at least one of vanadium and niobium.

Further additional features may be provided, including but not limited to the following: the fine grain steel alloy further comprising about 0.60 to about 1.50 weight percent chromium; the fine grain steel alloy further comprising about 0.01 to about 0.20 weight percent aluminum; the fine grain steel alloy further comprising about 0.01 to about 0.20 weight percent titanium; the fine grain steel alloy further comprising phosphorus in an amount not exceeding 0.025 weight percent; the fine grain steel alloy further comprising about 0.02 to about 0.06 weight percent sulfur; the fine grain steel alloy further comprising about 100 to about 200 ppm nitrogen; the fine grain steel alloy further comprising molybdenum in an amount not exceeding 0.10 weight percent; and the fine grain steel alloy being free of boron.

In some examples, the fine grain steel alloy may include iron, about 0.45 weight percent carbon, about 2.00 weight percent manganese, about 1.00 weight percent silicon, about 0.50 to about 0.70 weight percent chromium, and about 0.15 to about 0.25 weight percent of a transition metal, where the transition metal consists of at least one of vanadium and niobium.

Further additional features may be included, including but not limited to the following: an automotive component being created from the fine grain steel alloy; the automotive component being a crankshaft, a transmission shaft, a transmission case, a half shaft, or an axle shaft.

### BRIEF DESCRIPTION OF THE DRAWINGS

The drawings are provided for illustration purposes only and are not intended to limit this disclosure or the claims appended hereto.

FIG. 1 is a graph showing a conceptual time-temperature calculated phase diagram of a steel alloy according to the principles of the present disclosure;

FIG. 2A is a graph showing a prior art time-temperature diagram for a forging, quenching, and tempering process for conventionally forming high-strength steel alloys;

FIG. 2B is a graph showing time-temperature diagram for a forging and cooling process for forming high-strength steel alloys in accordance with the principles of the present disclosure;

FIG. 3 is a perspective view of a crankshaft formed of a steel alloy in accordance with the principles of the present disclosure; and

FIG. 4 is a perspective view of a transmission shaft formed of a steel alloy according to the principles of the present disclosure.

### DETAILED DESCRIPTION

High strength steel alloys having a fine grain microstructure and a smooth surface finish are provided. In comparison to other steel alloys, these steel alloys exhibit improved material strength and hardness, with relatively fine grain size. The steel alloys disclosed herein are useful for forming automotive components that undergo large loads and fatigue. For example, these steel alloys have a high content of a transition metal, such as vanadium and/or niobium, to control grain size; a high content of manganese to increase hardenability; and a high content of silicon to promote bainite by retarding pearlite formation and to increase surface oxidation resistance. With these new steel alloys, fine grains along with mixed microstructures of bainite and small amounts of pearlite and martensite can be achieved after control-cooling from the forging process. As a result, the conventional quenching-tempering (QT) process can be eliminated, if desired. Elimination of the QT process can save the cost of the heat treatment of the QT procedure, as well as reducing machining due to the reduction of distortion. In some cases, final strengths of up to 1400 MPa (HRC 43) can be achieved.

The steel alloys disclosed herein may contain iron, carbon, manganese, silicon, and at least one of a transition metal such as vanadium and niobium. The steel alloys may also contain chromium and may have an ideal diameter hardenability (DI) of about 7.9, which is comparably higher than the DI of steel alloy 1045 (DI of 0.9) and steel alloy 10V45 (DI of 1.2).

The steel alloys disclosed herein may be fine grain steel alloys and may include iron and by weight about 0.20 to about 0.60 weight percent carbon; about 1.80 to about 2.50 weight percent manganese; about 0.50 to about 1.20 weight percent silicon; and about 0.10 to about 0.25 weight percent of a transition metal, where the transition metal consists of at least one of vanadium and niobium. In other words, the transition metal may be all vanadium, all niobium, or a mixture vanadium and niobium. For example, Table 1 shows a first example of the steel alloy, which contains iron, carbon, manganese, silicon, and the transition metal that may include vanadium and/or niobium.

TABLE 1
Example 1 of a New Steel Alloy

| C (wt %) | Mn (wt %) | Si (wt %) | V/Nb (wt %) |
|---|---|---|---|
| 0.20-0.60 | 1.80-2.50 | 0.50-1.20 | 0.10-0.25 |

In some variations, the steel alloy may include iron and by weight about 0.20 to about 0.60 weight percent carbon; about 1.90 to about 2.20 weight percent manganese; about 0.20 to about 0.80 weight percent silicon; about 0.40-0.70 weight percent chromium; about 0.10 to about 0.25 weight percent of a transition metal, where the transition metal consists of vanadium, niobium, or both; about 0.01 to about 0.20 weight percent aluminum; and about 0.01 to about 0.20 weight percent titanium. For example, Table 2 shows a second example of the steel alloy, which contains iron, carbon, manganese, silicon, chromium, the transition metal that may include vanadium and/or niobium, aluminum, and titanium.

TABLE 2
Example 2 of a New Steel Alloy

| C (wt %) | Mn (wt %) | Si (wt %) | Cr (wt %) | V/Nb (wt %) | Al (wt %) | Ti (wt %) |
|---|---|---|---|---|---|---|
| 0.20-0.60 | 1.90-2.20 | 0.20-0.80 | 0.40-0.70 | 0.10-0.25 | 0.01-0.20 | 0.01-0.20 |

The steel alloy shown in Table 1 or Table 2 may also contain about 0.60 to about 1.50 weight percent chromium; about 0.01 to about 0.20 weight percent aluminum; about 0.01 to about 0.20 weight percent titanium; phosphorus in an amount not exceeding 0.025 weight percent; about 0.02 to about 0.06 weight percent sulfur; 100 to about 200 ppm nitrogen; and molybdenum in an amount not exceeding 0.10 weight percent. For example, Table 3 shows a form of the new steel alloy containing these additional alloying elements. It should be understand that the new steel alloy can have any combination of the listed elements below, and need not include all of them.

TABLE 3
Example 3 of a New Steel Alloy with Additional Elements

| C | Mn | Si | V/Nb | Cr | Al | Ti | P | S | N | Mb |
|---|---|---|---|---|---|---|---|---|---|---|
| (wt %) | (wt %) | (wt %) | (wt %) | (wt %) | (wt %) | (wt %) | (wt %) | (wt %) | (ppm) | (wt %) |
| 0.20-0.60 | 1.80-2.50 | 0.20-1.20 | 0.10-0.25 | 0.60-1.50 | 0.01-0.20 | 0.01-0.20 | <0.025 | 0.02-0.06 | 100-200 | <0.10 |

In one form, the fine grain steel alloy may contain about 0.45 weight percent carbon; about 2.00 weight percent manganese; about 1.00 weight percent silicon; about 0.50 to about 0.70 weight percent chromium; and about 0.15 to about 0.25 weight percent of the transition metal that includes at least one of vanadium and niobium. For example, this version of the steel alloy is illustrated below in Table 4. Though not shown in Table 4, the fourth example of the steel alloy may also contain other elements from Table 3; for example, the fourth example of the new steel alloy may contain about 150 ppm nitrogen and about 0.025 weight percent titanium.

TABLE 4
Example 4 of a New Steel Alloy

| C (wt %) | Mn (wt %) | Si (wt %) | V/Nb (wt %) | Cr (wt %) |
|---|---|---|---|---|
| 0.45 | 2.00 | 1.00 | 0.15-0.25 | 0.50-0.70 |

In some forms, the fine grain steel alloy may be free of boron.

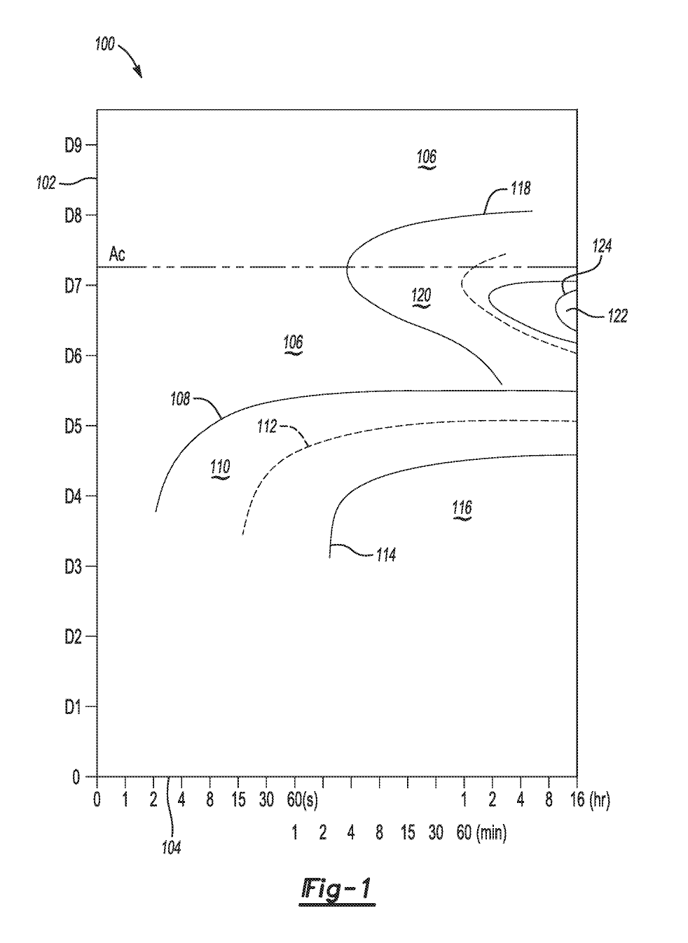

The new steel alloy may have a calculated phase diagram 100 as illustrated conceptually in FIG. 1. FIG. 1 is a conceptual illustration, and the new steel alloy need not have the exact phases corresponding to times and temperatures as shown in FIG. 1. Temperature is conceptually shown on the Y-axis, indicated at element 102, shown from a high of D₉ degrees C. down to a low of 0 degrees C.; and time is shown on the X-axis, indicated as element 104, from 0 seconds to 16 hours (not shown with equal spacing between time units).

At the highest temperatures, such as at D₈ and D₉, the steel alloy is liquid and has an austenite microstructure as indicated in section 106. Each solid line on the graph marks the boundary of a phase transformation as the alloy is cooled. For example, as the steel alloy is cooled past the line 108 into region 110, the steel alloy begins to form a bainite microstructure, mixed with the austenite microstructure. Line 108 is the 0% bainite line, and the region 110 is the bainite/austenite mixture region. At line 112, the steel alloy contains 50% bainite and 50% austenite. Line 114 is the 100% bainite line, such that the steel alloy no longer contains austenite in the region 116 beyond the 100% bainite line 114. Line 118 is the ferrite line such that the steel alloy contains a mixture of ferrite and austenite beyond the ferrite line 118 in region 120. Similarly, the steel alloy contains pearlite and ferrite in the pearlite/ferrite region 122 beyond the pearlite line 124; however, it should be noted that the steel alloy would need to be cooled very slowly (at times longer than, for example, 8 hours) to end up in the pearlite/ferrite region 122, as opposed to traditional steel alloys that have a pearlite/ferrite region occurring much more rapidly.

FIG. 1 shows that the new steel alloy may be cooled directly from a austenite microstructure in austenite region 106 at high temperatures D₅-D₉ down to a bainite/austenite mixture region 110, and ultimately to a microstructure region 116 containing mostly bainite over a relatively long period of time (shown as longer than an hour, by way of example, without crossing into the ferrite and pearlite regions 120, 122 during the cooling process to form large grains as pearlite or ferrite. This results in a mostly bainite microstructure in the new steel alloy having fine grains. As such, a controlled cooling process may be used to cool the new steel alloy during its production while maintaining a desirable microstructure, such as a microstructure having relatively fine grains and mostly bainite.

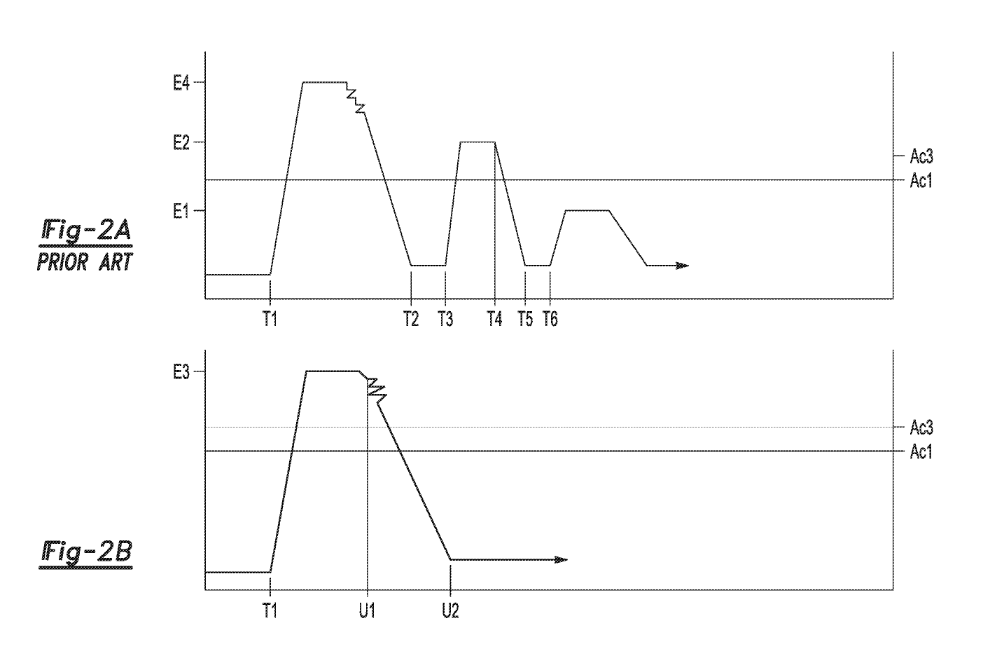

Referring now to FIG. 2A, a time-temperature diagram of a typical steel alloy production process is illustrated. The steel alloy is forged at a high temperature E4 starting at time T1 and ending at time T2, resulting in a large grain microstructure because the alloy passes through regions such as the pearlite and ferrite microstructure-forming regions during cooling. Because of the large grain microstructure, typical steel alloys are brittle and must undergo a reheating, followed by quenching and tempering, in order to reduce grain size and increase hardenability and strength. Thus, at time T3, the steel alloy is reheated to temperature E2 until time T4 and then quickly quenched until time T5. The steel alloy is further heated to a tempering temperature E1 beginning at time T6 to complete the tempering process. Reheating, quenching, and tempering is used to increase strength and toughness by decreasing grain size. In addition, due to decarburization at the elevated forging temperature E4, surfaces of the resultant part are shot-peened to improve fatigue life. The steel alloy may then be machined into a desired part.

Referring now to FIG. 2B, the new steel alloy may be produced without the reheating, quenching, and tempering processes shown in FIG. 2A. Instead, the new steel alloy is simply forged at time T1 at the temperature E3 and then cooled in a controlled manner between times U1 and U2, where the forging temperature E3 need not be as hot as the traditional forging temperature E4. Thus, E3 can be lower than E4. The microstructure of the new steel alloy already contains fine grains because the new steel alloy can be cooled without forming much pearlite and ferrite, as shown in FIG. 1. A mostly bainite microstructure with small amounts of pearlite and martensite can be formed. The controlled cooling may be accomplished by blowing air in a controlled manner onto the steel alloy, such as by letting the steel alloy go through a tunnel and blowing air on it, by way of example.

Thus, the new steel alloy is already strong and hard without the need for additional reheating, quenching, and tempering, as shown in FIG. 2A between times T3 and T6 and beyond. Accordingly, time and cost are saved from not having to perform the reheating, quenching, and tempering steps. In addition, cost savings are achieved because distortion and rework are reduced during machining. High silicon content reduces surface decarburization and improves part fatigue life.

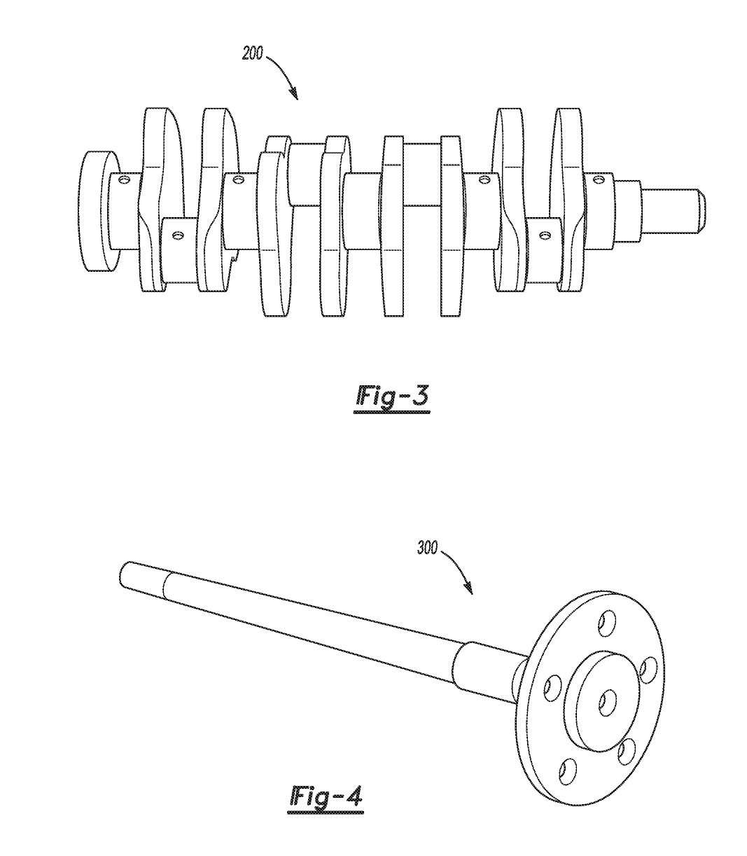

The fine grain steel alloys described herein may be used to manufacture a steel automotive component. Therefore, it is within the contemplation of the inventors herein that the disclosure extend to steel automotive components, including but not limited to crankshafts, transmission shafts, transmission cases, half shafts, axle shafts, and the like. For example, referring to FIG. 3 a crankshaft 200 is illustrated, which is made of any variation of the steel alloy described herein. In FIG. 4, a transmission shaft 300 is illustrated, which is made of any variation of the steel alloy described herein.

Furthermore, while the above examples are described individually, it will be understood by one of skill in the art having the benefit of this disclosure that amounts of elements described herein may be mixed and matched from the various examples within the scope of the appended claims.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A fine grain steel alloy comprising:
iron;
about 0.20 to about 0.60 weight percent carbon;
about 1.80 to about 2.50 weight percent manganese;
about 0.20 to about 1.20 weight percent silicon; and
about 0.10 to about 0.25 weight percent of a transition metal, the transition metal consisting of at least one of vanadium and niobium.

2. The fine grain steel alloy of claim 1, further comprising about 0.60 to about 1.50 weight percent chromium.

3. The fine grain steel alloy of claim 2, further comprising about 0.01 to about 0.20 weight percent aluminum.

4. The fine grain steel alloy of claim 3, further comprising about 0.01 to about 0.20 weight percent titanium.

5. The fine grain steel alloy of claim 4, further comprising about 0.02 to about 0.06 weight percent sulfur.

6. The fine grain steel alloy of claim 5, further comprising about 100 to about 200 ppm nitrogen.

7. The fine grain steel alloy of claim 6, further comprising phosphorus in an amount not exceeding 0.025 weight percent.

8. The fine grain steel alloy of claim 7, further comprising molybdenum in an amount not exceeding 0.10 weight percent.

9. The fine grain steel alloy of claim 4, wherein the fine grain steel alloy comprises:
about 0.45 weight percent carbon;
about 2.00 weight percent manganese;
about 1.00 weight percent silicon;
about 0.50 to about 0.70 weight percent chromium; and
about 0.15 to about 0.25 weight percent of a transition metal, the transition metal consists of at least one of vanadium and niobium.

10. The fine grain steel alloy of claim 9, wherein the fine grain steel alloy is free of boron.

11. An automotive component created from a fine grain steel alloy according to claim 4.

12. The automotive component of claim 11, wherein the automotive component is one of a crankshaft, a transmission shaft, a transmission case, a half shaft, and an axle shaft.

13. The automotive component of claim 12, wherein the automotive component is a crankshaft.

14. An automotive propulsion system component formed of a fine grain steel alloy, the fine grain steel alloy comprising:
iron;
about 0.20 to about 0.60 weight percent carbon;
about 1.80 to about 2.50 weight percent manganese;
about 0.20 to about 1.20 weight percent silicon; and
about 0.10 to about 0.25 weight percent of a transition metal, the transition metal consisting of at least one of vanadium and niobium.

15. The automotive propulsion system component of claim 14, wherein the fine grain steel alloy further comprises about 0.60 to about 1.50 weight percent chromium.

16. The automotive propulsion system component of claim 15, wherein the fine grain steel alloy further comprises about 0.01 to about 0.20 weight percent aluminum.

17. The automotive propulsion system component of claim 16, wherein the fine grain steel alloy further comprises about 0.01 to about 0.20 weight percent titanium.

18. The automotive propulsion system component of claim 17, wherein the fine grain steel alloy further comprises:
phosphorus in an amount not exceeding 0.025 weight percent;
about 0.02 to about 0.06 weight percent sulfur;
about 100 to about 200 ppm nitrogen; and
molybdenum in an amount not exceeding 0.10 weight percent.

19. The automotive propulsion system component of claim 18, wherein the automotive component is one of a crankshaft, a transmission shaft, a transmission case, a half shaft, and an axle shaft.

20. The automotive propulsion system component of claim 18, wherein the automotive component is a crankshaft.
